(19) United States
(12) Patent Application Publication
(10) Pub. No.: US 2012/0291586 A1
(43) Pub. Date: Nov. 22, 2012

(54) ACCELERATOR APPARATUS

(75) Inventors: Katsumi Watanabe, Chita-gun (JP); Masahiro Makino, Kariya-city (JP)

(73) Assignee: DENSO CORPORATION, Kariya-city (JP)

(21) Appl. No.: 13/462,007

(22) Filed: May 2, 2012

(30) Foreign Application Priority Data
May 20, 2011 (JP) 2011-113287

(51) Int. Cl. G05G 1/38

(52) U.S. Cl. 74/513

(57) ABSTRACT

A pad is adapted to receive a pedal force of a driver. A pedal arm is rotatably supported by a support body. A sensor protector is placed in the pedal arm on one side of a rotational angle sensor where the pad is located in a longitudinal direction of the pedal arm. The sensor protector is recessed from the pedal arm in a direction parallel to a rotational axis of the pedal arm and protrudes from the pedal arm in a rotational direction of the pedal arm.

### CROSS REFERENCE TO RELATED APPLICATION

This application is based on and incorporates herein by reference Japanese Patent Application No. 2011-113287 filed on May 20, 2011.

### TECHNICAL FIELD

The present disclosure relates to an accelerator apparatus for a vehicle.

### BACKGROUND

A known accelerator apparatus controls a traveling speed of a vehicle according to an amount of depression of a pedal, which is depressed by a foot of a driver of the vehicle. In the accelerator apparatus, a pedal arm is rotatably connected to a support body, which is securely installed to the vehicle. When a pedal force is exerted from the foot of the driver against a pad, which is formed in an end portion of the pedal arm, the pedal arm is rotated forward or backward.

A rotational angle sensor, which is provided around a rotational axis of the pedal arm, outputs a signal, which corresponds to a rotational angle of the pedal arm, to an electronic control unit (ECU) of the vehicle. Thereby, the ECU controls each corresponding component of the engine based on the signal received from the rotational angle sensor and speed information of the vehicle.

In an accelerator apparatus recited in JP2004-155340A, a groove, which is recessed in a direction parallel to a rotational axis, is formed in an outer wall of the pedal arm. For instance, when the foot of the driver contacts a side surface of the pedal arm, a load is applied to the pedal arm in the direction parallel to the rotational axis of the pedal arm. At that time, the pedal arm may be bent, i.e., may be deformed about the groove. Thus, the load, which is exerted against the rotational angle sensor, is reduced, and thereby it is possible to limit an abnormality in an output characteristic of the rotational angle sensor.

However, in JP2004-155340A, a cross-sectional area of the pedal arm is reduced at the location where the groove is formed, and thereby a rigidity of the pedal arm is substantially reduced. As a result, when the normal load is applied against the pedal arm in the direction parallel to the rotational axis or in the rotational direction, the pedal arm may possibly be easily bent, i.e., deformed about the groove.

### SUMMARY

The present disclosure is made in view of the above points.

According to the present disclosure, there is provided an accelerator apparatus for a vehicle. The accelerator apparatus includes a support body, a pad, a pedal arm, an urging member, a rotational angle sensor and a sensor protector. The support body is adapted to be installed to a body of the vehicle. The pad is adapted to receive a pedal force of a driver of the vehicle. The pedal arm is rotatably supported by the support body and is rotatable about a rotational axis in a rotational direction by the pedal force of the driver applied to the pad. The pedal arm is adapted to be rotated in a first direction when the pedal force applied to the pad is increased, and the pedal arm is adapted to be rotated in a second direction, which is opposite from the first direction, when the pedal force applied to the pad is decreased. The urging member urges the pedal arm in the second direction. The rotational angle sensor senses a rotational angle of the pedal arm relative to the support body. The sensor protector is placed in the pedal arm on one side of the rotational angle sensor where the pad is located in a longitudinal direction of the pedal arm. The sensor protector is recessed from the pedal arm in a direction parallel to the rotational axis of the pedal arm and protrudes from the pedal arm in the rotational direction of the pedal arm.

### BRIEF DESCRIPTION OF THE DRAWINGS

The drawings described herein are for illustration purposes only and are not intended to limit the scope of the present disclosure in any way.

FIG. 1 is a lateral view of an accelerator apparatus according to a first embodiment of the present disclosure;

FIG. 2 is a cross sectional view taken along line II-II in FIG. 1;

FIG. 3 is a view taken from a direction of an arrow III in FIG. 1;

FIG. 4 is a view taken in a direction of an arrow IV in FIG. 1;

FIG. 5 is a view taken in a direction of an arrow V in FIGS. 3 and 4;

FIG. 6 is a cross sectional view taken along line VI-VI in FIGS. 1 and 5;

FIG. 7 is a cross sectional view taken along line VII-VII in FIGS. 1 and 5;

FIG. 8 is a lateral view of an accelerator apparatus according to a second embodiment of the present disclosure; and

FIG. 9 is a lateral view of an accelerator pedal of the accelerator apparatus according of the second embodiment.

### DETAILED DESCRIPTION

Embodiments of the present disclosure will be described with reference to the accompanying drawings.

### First Embodiment

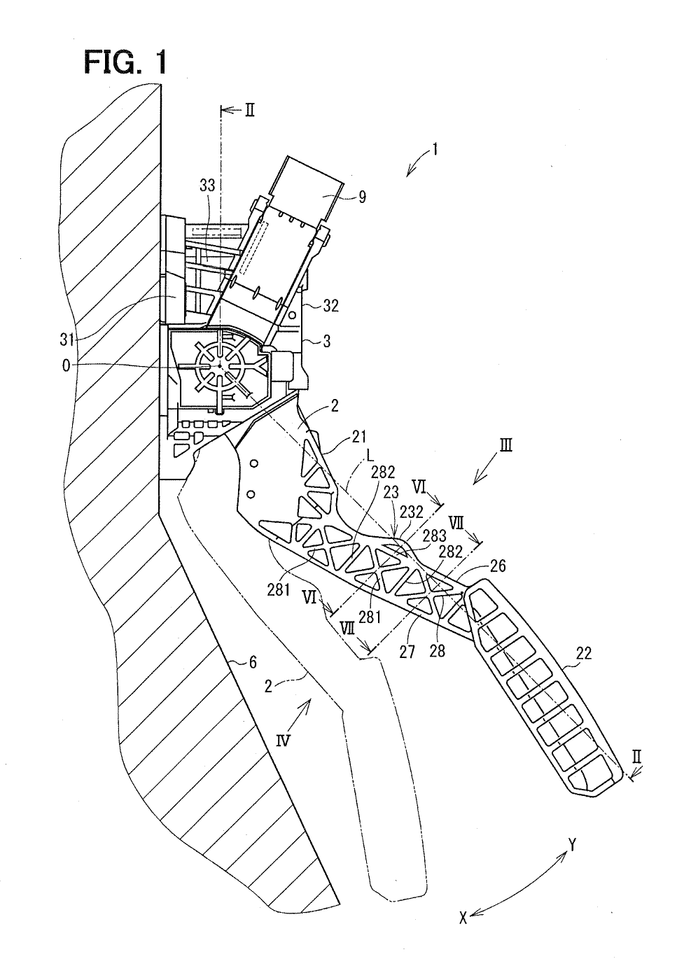

FIGS. 1 to 8 show an accelerator apparatus according to a first embodiment of the present disclosure.

The accelerator apparatus 1 is installed to a vehicle (e.g., an automobile) and controls each corresponding component of an internal combustion engine of the vehicle based on the amount of depression of the accelerator pedal 2, which is depressed by a foot of a driver of the vehicle. The accelerator apparatus 1 of the present embodiment is of a drive-by-wire type. Specifically, a rotational angle of the accelerator pedal 2 relative to a housing 3 is sensed with a rotational angle sensor 5 and is converted into a corresponding electric signal at the rotational angle sensor 5. Then, this electric signal is outputted from the rotational angle sensor 5 to an undepicted electronic control unit (ECU) of the vehicle. The ECU controls an operational state of the engine by controlling each corresponding component of the engine (e.g., an opening degree of a throttle apparatus, a fuel injection quantity of each corresponding injector) based on the signal of the rotational angle sensor 5 and speed information of the vehicle.

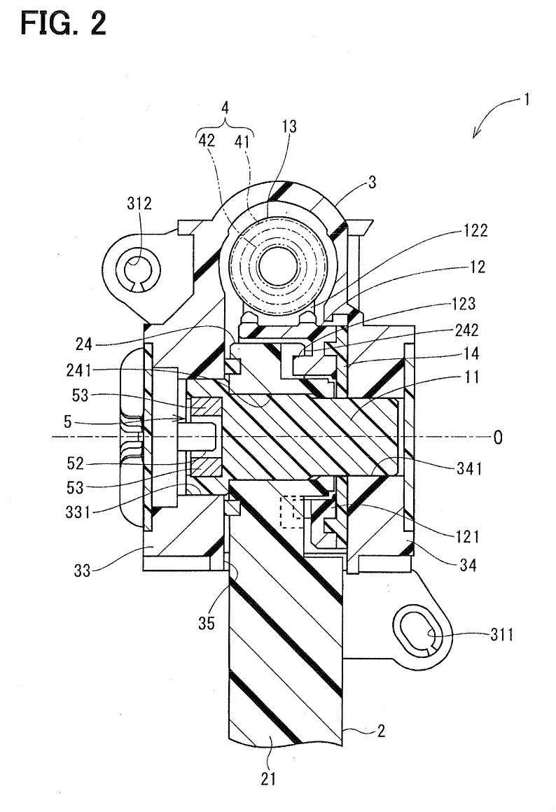

As shown in FIGS. 1 and 2, the accelerator apparatus 1 includes the accelerator pedal 2, the housing 3, a spring (serving as an urging member or an urging means) 4 and the rotational angle sensor 5. The accelerator pedal 2 is adapted to be depressed by the foot of the driver of the vehicle. The housing 3 serves as a support body, which is securely installed to a body (hereinafter referred to as a vehicle body) 6 of the vehicle and rotatably supports the accelerator pedal 2.

The housing 3 is made of, for example, resin and is configured generally into a box form. More specifically, the housing 3 includes a bottom plate 31, a top plate 32, a left side plate 33 and a right side plate 34. The bottom plate 31 and the top plate 32 are generally parallel to each other and are opposed to each other. The left side plate 33 and the right side plate 34 are generally parallel to each other and connect between the bottom plate 31 and the top plate 32. The housing 3 has an opening 35, through which the accelerator pedal 2 is received into the housing 3.

Mount holes 311, 312 are formed in the bottom plate 31. Bolts are installed in the mount holes 311, 312, so that the housing 3 is securely installed to the vehicle body 6.

The accelerator pedal 2 includes a pedal arm 21, a pad 22 and a sensor protector 23 and are integrally formed from, for example, resin.

The pedal arm 21 is inserted into the housing 3 through the opening 35 of the housing 3. The pad 22 is provided at a free end portion of the pedal arm 21. The pedal arm 21 has a cylindrical tubular portion 24, which is placed at an opposite side that is opposite from the pad 22 in a longitudinal direction of the pedal arm 21 at an inside of the housing 3.

A hole 241 extends through the cylindrical tubular portion 24 in a direction of a rotational axis O. A shaft member 11 is fitted into the hole 241. One end part of the shaft member 11 is rotatably supported by a recess 331, which is formed in an inner wall of the side plate 33 of the housing 3, and the other end part of the shaft member 11 is rotatably supported by a recess 341, which is formed in an inner wall of the side plate 34 of the housing 3. Thereby, the accelerator pedal 2 is integrally rotatable with the shaft member 11 about the rotational axis O of the shaft member 11.

In the following discussion, a rotational direction of the accelerator pedal 2, in which the accelerator pedal 2 is depressed by an increased pedal force applied from the foot of the driver, will be referred to as a first direction X, and the opposite rotational direction of the accelerator pedal 2, which is opposite from the first direction X, will be referred to as a second direction Y. In other words, the pedal arm 21 of the accelerator pedal 2 is adapted to be rotated in the first direction X when the pedal force applied to the pad 22 is increased, and the pedal arm 21 is adapted to be rotated in the second direction Y when the pedal force applied to the pad 22 is decreased.

As shown in FIGS. 1, 6 and 7, the accelerator pedal 2 includes a lateral wall 25, an upper wall 26, a lower wall 27 and reinforcing walls 28. The lateral wall 25 extends in the rotational direction of the accelerator pedal 2. The upper wall 26 and the lower wall 27 extend in the direction parallel to the rotational axis O from two opposed ends, respectively, of the lateral wall 25, which are opposed to each other in the rotational direction. The reinforcing walls 28 are placed between the upper wall 26 and the lower wall 27 and extend from the lateral wall 25 in the direction parallel to the rotational axis O of the accelerator pedal 2. The reinforcing walls 28 include a plurality of X-reinforcing walls 281 and a plurality of I-reinforcing walls 282. Each X-reinforcing wall 281 is configured into an X-shape in a view taken in the direction parallel to the rotational axis O. Each I-reinforcing wall 282 is configured into an I-shape in the view taken in the direction parallel to the rotational axis O.

The sensor protector 23 is placed in the pedal arm 21 on one side of the rotational angle sensor 5 where the pad 22 is located in the longitudinal direction of the pedal arm 21. That is, the sensor protector 23 is placed between the cylindrical tubular portion 24 and the pad 22 in the longitudinal direction of the pedal arm 21 and is formed integrally with the pedal arm 21. The sensor protector 23 is recessed in the pedal arm 21 in the direction parallel to the rotational axis O and protrudes in the rotational direction. Portions of the lateral wall 25, the upper wall 26, the lower wall 27 and the X-reinforcing wall 281, which form the sensor protector 23, have a plate wall thickness, which is generally the same as a plate wall thickness of adjacent portions of the lateral wall 25, the upper wall 26, the lower wall 27 and the X-reinforcing wall 281, which are adjacent to the sensor protector 23 and form the pedal arm 21.

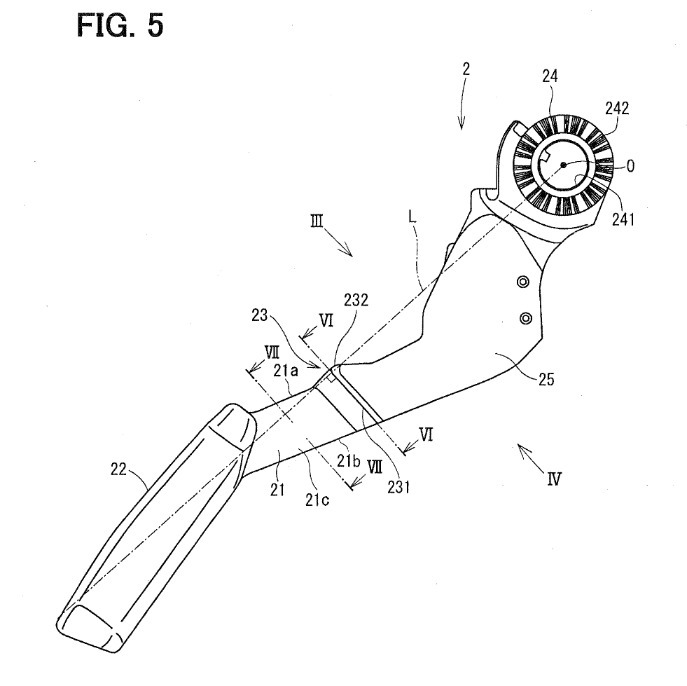

The sensor protector 23 includes a protrusion 232 and a groove 231. With reference to FIG. 5, among upper and lower outer wall surfaces 21a, 21b of the pedal arm 21, which are outer wall surfaces of the upper and lower walls 26, 27, respectively, and are opposed to each other in the rotational direction, the protrusion 232 outwardly protrudes from the upper outer wall surface 21a of the pedal arm 21 in the rotational direction on the side of the pedal arm 21, which is opposite from the side where the housing 3 is installed to the vehicle body 6. The groove 231 is placed in a lateral outer wall surface 21c of the pedal arm 21, which is a lateral outer wall surface of the lateral wall 25 located at one, side of the pedal arm 21 in the direction parallel to the rotational axis O, and the groove 231 is recessed in the direction parallel to the rotational axis O.

With reference to FIG. 1, the upper wall 26 of the protrusion 232 protrudes from the pedal arm 21 in the direction opposite from the vehicle body 6 in the rotational direction. The protrusion 232 extends from one of adjacent two of the I-reinforcing walls 282, which is located on the cylindrical tubular portion 24 side, to the other one of the adjacent two of the I-reinforcing walls 282, which is located on the pad 22 side. The protrusion 232 is configured generally into a triangular form in the view taken in the direction parallel to the rotational axis O. The protrusion 232 is configured such that an apex of the triangle of the protrusion 232 forms a gently curved surface, which extends in the direction parallel to the rotational axis O.

The groove 231 is recessed in the direction parallel to the rotational axis O. Furthermore, the groove 231 extends from the upper outer wall surface 21a to the lower outer wall surface 21b of the pedal arm 21 in the rotational direction.

The groove 231 is located between the one of the adjacent two of the I-reinforcing walls 282, which is located on the cylindrical tubular portion 24 side, and the other one of the adjacent two of the I-reinforcing walls 282, which is located on the pad 22 side. The groove 231 extends from the apex of the protrusion 232, which outwardly protrudes from the upper outer wall surface 21a of the pedal arm 21 in the rotational direction, to the lower outer wall surface 21b of the pedal arm 21, which is located on the opposite side with respect to the protrusion 232 in the rotational direction. With reference to FIGS. 1 and 5, the groove 231 extends generally perpendicular to an imaginary straight line L, which connects between the rotational axis O of the pedal arm 21 and the pad 22.

The sensor protector 23 includes a reinforcing wall 283 between the upper wall 26 and a corresponding one of the X-reinforcing walls 281. The reinforcing wall 283 generally extends in a plane. A pad 22 side part of the upper wall 26 of the pedal arm 21, which is located on the pad 22 side of the sensor protector 23 in the longitudinal direction of the pedal arm 21, and a cylindrical tubular portion 24 side part of the upper wall 26 of the pedal arm 21, which is located on the cylindrical tubular portion 24 side of the sensor protector 23 in the longitudinal direction of the pedal arm 21, extend in this plane of the reinforcing wall 283. That is, the reinforcing wall 283, the pad 22 side part of the upper wall 26 of the pedal arm 21 and the cylindrical tubular portion 24 side part of the upper wall 26 of the pedal arm 21 extend along this common plane. The reinforcing wall 283 connects between the pad 22 side part of the upper wall 26 of the pedal arm 21 and the cylindrical tubular portion 24 side part of the upper wall 26 of the pedal arm 21. More specifically, a number of the reinforcing walls 28 located in the sensor protector 23 is larger than a number of the reinforcing walls 28 located in an adjacent part of the pedal arm 21, which is adjacent to the sensor protector 23 in the longitudinal direction of the pedal arm 21.

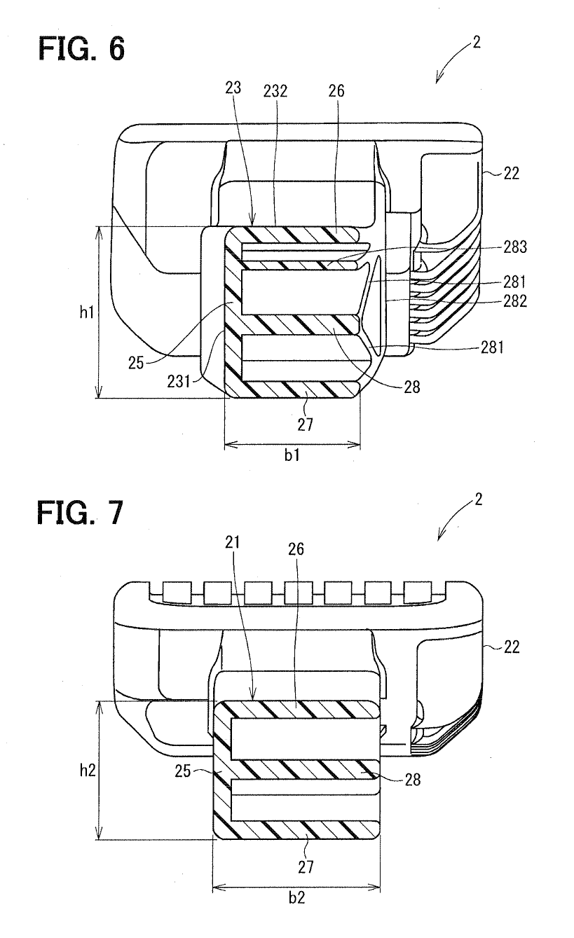

A width b1 and a height h1 of the sensor protector 23 of FIG. 6 and a width b2 and a height h2 of the pedal arm 21 of FIG. 7 satisfy the following relationships: b1<b2, h1>h2 and b1×h1≧b2×h2.

Specifically, a minimum cross-sectional area of the sensor protector 23 measured in the extending direction of the groove 231 in FIG. 6 is equal to or larger than that of the adjacent part of the pedal arm 21, which is shown in FIG. 7 and is located on the side of the sensor protector 23 where the pad 22 is placed in the longitudinal direction of the pedal arm 21. In this way, the accelerator pedal 2 maintains the appropriate rigidity against the load applied in the direction parallel to the rotational axis O and the load applied in the rotational direction.

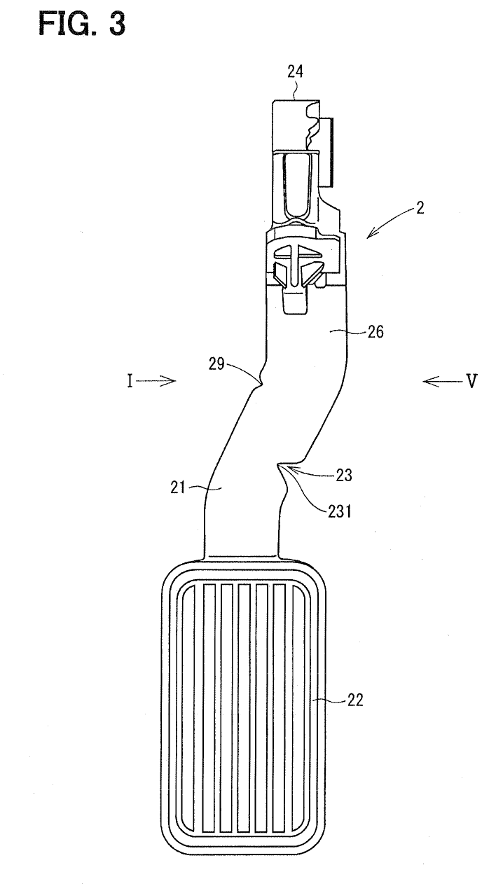

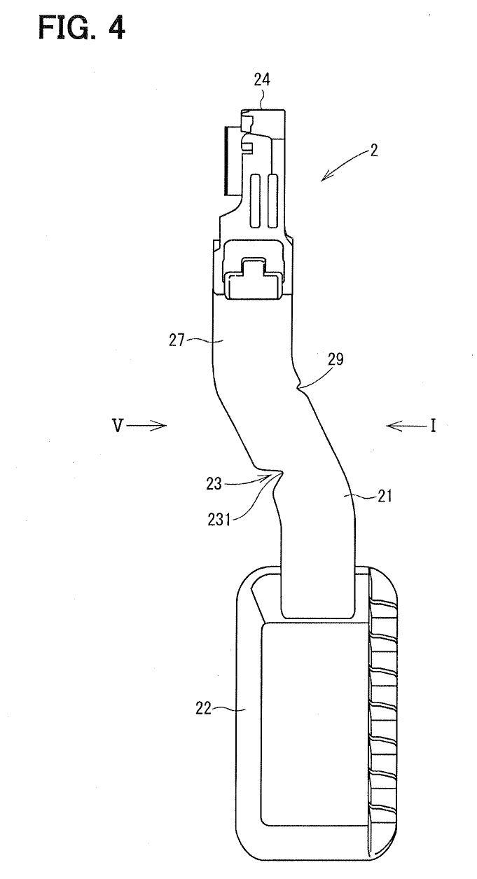

As shown in FIGS. 3 and 4, the pedal arm 21 includes a second groove 29. The second groove 29 is located between the sensor protector 23 and the cylindrical tubular portion 24 in the longitudinal direction of the pedal arm 21 and is recessed in the pedal arm 21 in the direction parallel to the rotational axis O. The second groove 29 extends from the upper wall 26 to the lower wall 27 of the pedal arm 21. The second groove 29 is generally parallel to the groove 231 of the sensor protector 23. An amount of recess of the second groove 29 is smaller than an amount of recess of the groove 231 of the sensor protector 23.

The second groove 29 is placed at a location where a distance between the upper wall 26 and the lower wall 27 of the pedal arm 21 is longer than a distance between the upper wall 26 and the lower wall 27 of the sensor protector 23. Therefore, the minimum cross-sectional area of the part (the part of the second groove 29) of pedal arm 21 measured in the extending direction of the second groove 29 is equal to or larger than that of an adjacent part of the pedal arm 21, which is located on a side of the second groove 29 where the pad 22 is placed in the longitudinal direction of the pedal arm 21. In this way, the accelerator pedal 2 maintains the appropriate rigidity against the load applied in the direction parallel to the rotational axis O and the load applied in the rotational direction.

As shown in FIG. 2, a rotor 12 is provided on an axial side of the cylindrical tubular portion 24. The rotor 12 includes an annular portion 121 and a spring holding portion 122. The annular portion 121 is configured into an annular form. The spring holding portion 122 outwardly protrudes from the annular portion 121 in a radial direction of the annular portion 121. The annular portion 121 of the rotor 12 is located on a radially outer side of the cylindrical tubular portion 24 in a radial direction of the cylindrical tubular portion 24 such that the annular portion 121 is rotatable relative to the cylindrical tubular portion 24.

A plurality of bevel teeth 123, each of which has a tilted surface, is formed in a tubular portion 24 side surface of the annular portion 121 such that the bevel teeth 123 are arranged one after another in a circumferential direction. Furthermore, a plurality of bevel teeth 242, each of which has a tilted surface, is formed in an annular portion 121 side surface of the cylindrical tubular portion 24 such that the bevel teeth 242 are arranged one after another in a circumferential direction. When the driver of the vehicle applies the pedal force to the pad 22 of the accelerator pedal 2, the bevel teeth 242 of the cylindrical tubular portion 24 are engaged with the bevel teeth 123 of the annular portion 121, so that the annular portion 121 is rotated together with the cylindrical tubular portion 24. At this time, the annular portion 121 is urged toward the side plate 34 side through the tilted surfaces of the bevel teeth 123 and the tilted surfaces of the bevel teeth 242. A friction plate 14 is placed between the annular portion 121 and the side plate 34 to apply a frictional force to the annular portion 121. In this way, the frictional force, which corresponds to a rotational angle of the accelerator pedal 2, is applied to the accelerator pedal 2. Thereby, a predetermined hysteric characteristic can be applied to the accelerator pedal 2 in each of the X-direction and the Y-direction.

A holder 13, which is configured into a saucer shape, is provided to the top plate 32 side of the spring holding portion 122. A spring 4 is placed between the holder 13 and the top plate 32. The spring 4 is a double coil spring, which includes an outer coil spring 41 and an inner coil spring 42.

The spring 4 has an axially expanding force (urging force) and thereby urges the holder 13 against the spring holding portion 122 side of the rotor 12. The spring holding portion 122 of the rotor 12 is urged by the urging force of the spring 4 toward the bottom plate 31 side, so that the annular portion 121 is rotated. When the annular portion 121 is rotated, the accelerator pedal 2, which includes the cylindrical tubular portion 24, is also rotated through the engagement between the bevel teeth 123 and the bevel teeth 242. That is, the spring 4 urges the accelerator pedal 2 in the opposite direction (the second direction Y), which is opposite from the rotational direction of the accelerator pedal 2 that is depressed by the pedal force of the driver of the vehicle.

The rotational angle sensor 5 includes a Hall IC (a magnetic sensing device or magnetic sensing means) 52 and two permanent magnets (serving as a magnetic flux generating device or a magnetic flux generating means) 53. The Hall IC 52 is fixed to the side plate 33 side of the housing 3. The magnets 53 are fixed to the side plate 33 side of the shaft member 11. A magnetic flux, which is generated from the magnets 53, flows in a direction perpendicular to the rotational axis O of the accelerator pedal 2. The Hall IC 52 outputs a voltage signal that corresponds to a density of the magnetic flux, which passes through a magnetic sensing surface of the Hall IC 52. This voltage signal is transmitted to the ECU of the vehicle through a terminal of a connector 9, which is formed in the housing 3. Thereby, the ECU senses the rotational angle of the accelerator pedal 2 and controls each corresponding component of the engine.

Now, an operation of the accelerator apparatus 1 will be described.

As shown in FIG. 1, in a state where the pedal force of the driver is not applied to the pad 22, the accelerator pedal 2 is maintained at a full closing position (a position, at which the accelerator is placed in a fully closed state) by the urging force of the spring 4. At this time, the rotational angle sensor 5 outputs a signal, which indicates the placement of the accelerator pedal 2 in the full closing position, to the ECU.

When the pedal force, which is applied by the drive to the pad 22, is increased, the accelerator pedal 2 is rotated in the first direction X (see a dot-dot-dash line in FIG. 1). When the pedal force, which is applied by the drive to the pad 22, is decreased, the accelerator pedal 2 is rotated in the second direction Y. At this time, the rotational angle sensor 5 outputs a signal, which indicates a predetermined amount of rotation of the accelerator pedal 2, to the ECU.

As discussed above, the minimum cross-sectional area of the sensor protector 23 measured in the extending direction of the groove 231 is equal to or larger than that of the adjacent part of the pedal arm 21, which is located on the side of the sensor protector 23 where the pad 22 is placed in the longitudinal direction of the pedal arm 21. Therefore, the appropriate rigidity of the accelerator pedal 2 can be maintained against the load applied in the direction parallel to the rotational axis O and the load applied in the rotational direction. During the normal operation of the accelerator apparatus 1, when the pedal force of the driver is applied to the pad 22, the pedal force of the driver and the urging force of the spring 4 are applied to the pedal arm 21. At this time, the deformation of the sensor protector 23 in the rotational direction can be limited. Furthermore, the deformation of the sensor protector 23 in the direction parallel to the rotational axis O can be limited in the case where the load is applied to the accelerator pedal 2 in the direction parallel to the rotational axis O of the accelerator pedal 2 through, for example, contacting of the foot of the driver to the lateral surface of the pedal arm 21.

In contrast, when an excessive load, which causes an abnormality in the output characteristic of the rotational angle sensor 5, is applied to the accelerator pedal 2 in the rotational direction, such a load is concentrated in the sensor protector 23. Therefore, the accelerator pedal 2 is bent, i.e., is deformed about the sensor protector 23 toward the pad 22 side.

Now, the advantages of the present embodiment will be described.

(1) In the present embodiment, the sensor protector 23 is recessed in the pedal arm 21 in the direction parallel to the rotational axis O and protrudes in the rotational direction. The minimum cross-sectional area of the sensor protector 23 measured in the extending direction of the groove 231 is equal to or larger than that of the pad 22 side part of the pedal arm 21, which is adjacent to the sensor protector 23 and is located on the pad 22 side of the sensor protector 23 in the longitudinal direction of the pedal arm 21. Thereby, at the time of the normal operation of the accelerator apparatus 1, the appropriate rigidity of the pedal arm 21 can be maintained against the load in the direction parallel to the rotational axis O of the pedal arm 21 or the load in the rotational direction of the pedal arm 21.

In contrast, when the large load, which may affect the output of the rotational angle sensor 5, is applied to the pedal arm 21 in the rotational direction, the pad 22 side part of the pedal arm 21 is bent, i.e., is deformed about the groove 231 of the sensor protector 23. Thereby, the rotational angle sensor 5 can be protected.

(2) In the present embodiment, the groove 231 of the sensor protector 23 extends generally perpendicular to the imaginary straight line L, which connects between the rotational axis O of the pedal arm 21 and the pad 22. Therefore, an application direction of the pedal force, which is applied by the driver against the pad 22, is generally parallel to the extending direction of the groove 231. Thus, it is possible to limit the deformation of the pedal arm 21 about the sensor protector 23 against the load applied in the rotational direction of the pedal arm 21.

In contrast, in the case where the excessively large load is applied to the pedal arm 21 in the rotational direction of the pedal arm 21, the stress is reliably concentrated in the sensor protector 23. Therefore, the sensor protector 23 can reliably protect the rotational angle sensor 5.

(3) In the present embodiment, the sensor protector 23 includes the reinforcing wall 283 at the location between the X-reinforcing wall 281 and the upper wall 26. The reinforcing wall 283 connects between the pad 22 side part of the upper wall 26 of the pedal arm 21, which is located on the pad 22 side of the sensor protector 23 in the longitudinal direction of the pedal arm 21, and the cylindrical tubular portion 24 side part of the upper wall 26 of the pedal arm 21, which is located on the cylindrical tubular portion 24 side of the sensor protector 23 in the longitudinal direction of the pedal arm 21. Thereby, the cross-sectional area of the sensor protector 23 can be made equal to or larger than that of the pad 22 side part of the pedal arm 21, which is located on the pad 22 side of the second groove 29, without a need for changing the plate wall thickness of the lateral wall 25, the upper wall 26 and the lower wall 27.

(4) In the present embodiment, the protrusion 232 of the sensor protector 23 protrudes from the pedal arm 21 on the opposite side, which is opposite from the side where the housing (the support body) 3 is installed to the vehicle body 6. In this way, the pedal arm 21 can be placed adjacent to the vehicle body 6, and thereby a space in a vehicle cabin (passenger compartment) of the vehicle can be effectively used.

### Second Embodiment

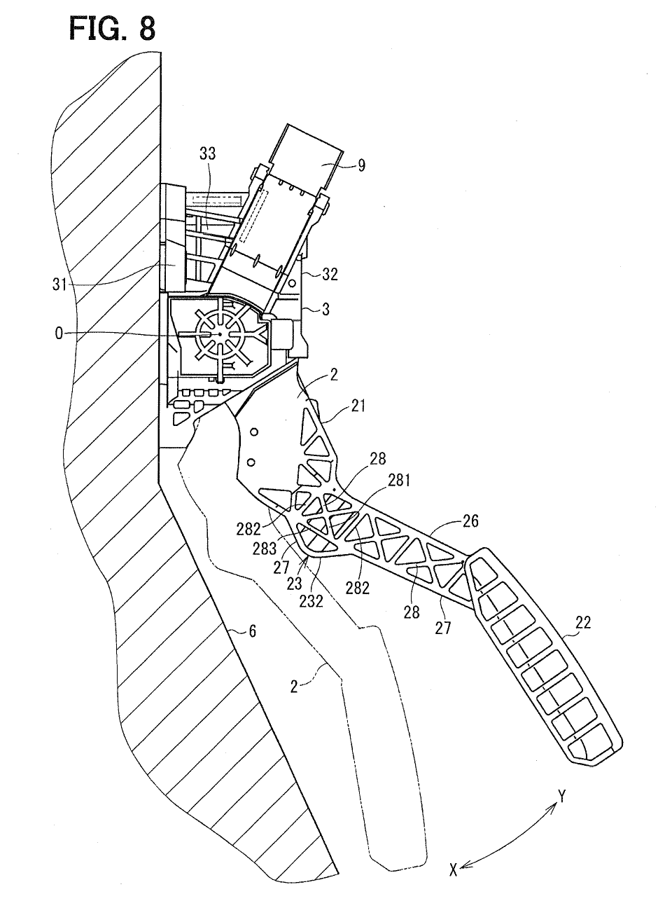

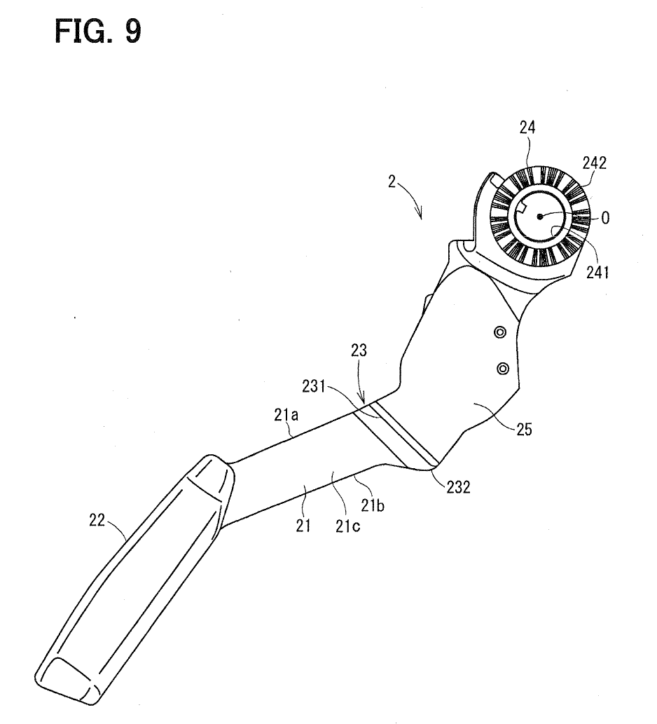

FIGS. 8 and 9 show an accelerator apparatus according to a second embodiment of the present disclosure. In the present embodiment, components, which are similar to those discussed in the first embodiment will be indicated by the same reference numerals and will not be discussed further. In the present embodiment, the lower wall 27 of the protrusion 232 of the sensor protector 23 protrudes from the lower outer wall surface 21b of the pedal arm 21 on the vehicle body 6 side. The protrusion 232 protrudes from the pedal arm 21 to an extent that does not cause an interference with the vehicle body 6 (i.e., does not contact the vehicle body 6) when the pedal arm 21 is rotated in the first direction X toward the vehicle body 6.

The sensor protector 23 includes the reinforcing wall 283, which connects between the pad 22 side part of the lower wall 27 of the pedal arm 21, which is located on the pad 22 side of the sensor protector 23 in the longitudinal direction of the pedal arm 21, and the cylindrical tubular portion 24 side part of the lower wall 27 of the pedal arm 21, which is located on the cylindrical tubular portion 24 side of the sensor protector 23 in the longitudinal direction of the pedal arm 21. The reinforcing wall 283 generally extends in a plane. The pad 22 side part of the lower wall 27 of the pedal arm 21, which is located on the pad 22 side of the sensor protector 23 in the longitudinal direction of the pedal arm 21, and the cylindrical tubular portion 24 side part of the lower wall 27 of the pedal arm 21, which is located on the cylindrical tubular portion 24 side of the sensor protector 23 in the longitudinal direction of the pedal arm 21, extend in this plane of the reinforcing wall 283. More specifically, the sensor protector 23 includes the greater number of the reinforcing walls 28 in comparison to the adjacent part of the pedal arm 21, which is adjacent to the sensor protector 23. The minimum cross-sectional area of the sensor protector 23 measured in the extending direction of the groove 231 is equal to or larger than that of the pad 22 side part of the pedal arm 21, which is located on the pad 22 side of the sensor protector 23 in the longitudinal direction of the pedal arm 21. In this way, the accelerator pedal 2 maintains the appropriate rigidity relative to the load applied in the direction parallel to the rotational axis O and the load applied in the rotational direction.

In the present embodiment, the protrusion 232 of the sensor protector 23 protrudes from the pedal arm 21 on the vehicle body 6 side, so that the driver of the vehicle may not easily see and notice the protrusion 232.

Now, modifications of the above embodiments will be described.

In the above embodiments, the recesses (holes) are provided in the pedal arm 21 and the sensor protector 23. Alternatively, the pedal arm and the sensor protector may be formed as a solid resin component.

In the above embodiments, the sensor protector 23 has the one groove 231 and the one protrusion 232. Alternatively, the sensor protector may include two or more grooves (a plurality of grooves) and two or more protrusions (a plurality of protrusions). In such a case, the grooves may be opposed to each other in the direction parallel to the rotational axis O or may be opposed to each other in the rotational direction.

In the above embodiments, the pedal arm 21 and the sensor protector 23 are made of the resin. Alternatively, the pedal arm and the sensor protector may be made of metal.

In the above embodiments, the spring 4 and the rotational angle sensor 5 are received in the housing, which is configured into the box form. However, the shape of the housing is not limited to the box form and may be changed to any other appropriate shape. Also, the spring 4 and the rotational angle sensor 5 may be separately received in the housing.

As discussed above, the present disclosure is not limited to the above embodiment, and the above embodiment may be modified within the spirit and scope of the present disclosure.

What is claimed is:

1. An accelerator apparatus for a vehicle, comprising:
a support body that is adapted to be installed to a body of the vehicle;
a pad that is adapted to receive a pedal force of a driver of the vehicle;
a pedal arm that is rotatably supported by the support body and is rotatable about a rotational axis in a rotational direction by the pedal force of the driver applied to the pad, wherein the pedal arm is adapted to be rotated in a first direction when the pedal force applied to the pad is increased, and the pedal arm is adapted to be rotated in a second direction, which is opposite from the first direction, when the pedal force applied to the pad is decreased;
an urging member that urges the pedal arm in the second direction;
a rotational angle sensor that senses a rotational angle of the pedal arm relative to the support body; and
a sensor protector that is placed in the pedal arm on one side of the rotational angle sensor where the pad is located in a longitudinal direction of the pedal arm, wherein the sensor protector is recessed from the pedal arm in a direction parallel to the rotational axis of the pedal arm and protrudes from the pedal arm in the rotational direction of the pedal arm.

2. The accelerator apparatus according to claim 1, wherein:
the sensor protector includes:
a groove that is placed in a lateral outer wall surface of the pedal arm located at one side of the pedal arm in the direction parallel to the rotational axis and is recessed in the lateral outer wall surface in the direction parallel to the rotational axis, wherein the groove extends from an upper outer wall surface to a lower outer wall surface of the pedal arm in the rotational direction of the pedal arm, and the upper outer wall surface and the lower outer wall surface are opposed to each other in the rotational direction of the pedal arm; and
a protrusion that protrudes from one of the upper and lower outer wall surfaces of the pedal arm in the rotational direction of the pedal arm; and
a minimum cross-sectional area of the sensor protector, which is measured in an extending direction of the groove, is equal to or larger than that of an adjacent part of the pedal arm, which is located on a side of the sensor protector where the pad is placed in the longitudinal direction of the pedal arm.

3. The accelerator apparatus according to claim 2, wherein:
the protrusion of the sensor protector is configured generally into a triangular form in a view taken in the direction parallel to the rotational axis of the pedal arm; and
the groove of the sensor protector extends from an apex of the protrusion, which protrudes from the one of the upper and lower outer wall surfaces of the pedal arm in the rotational direction, to the other one of the upper and lower outer wall surfaces of the pedal arm.

4. The accelerator apparatus according to claim 2, wherein the groove of the sensor protector extends generally perpendicular to an imaginary straight line, which connects between the rotational axis of the pedal arm and the pad.

5. The accelerator apparatus according to claim 1, wherein:
the pedal arm and the sensor protector are integrally formed from resin and includes:
a lateral wall that extends in the rotational direction of the pedal arm;
an upper wall and a lower wall that extend in the direction parallel to the rotational axis from two opposed ends, respectively, of the lateral wall, which are opposed to each other in the rotational direction; and
a plurality of reinforcing walls that are placed between the upper wall and the lower wall and extend from the lateral wall in the direction parallel to the rotational axis; and
a number of the reinforcing walls located in the sensor protector is larger than a number of the reinforcing walls located in an adjacent part of the pedal arm, which is adjacent to the sensor protector in the longitudinal direction of the pedal arm.

6. The accelerator apparatus according to claim 1, wherein the protrusion protrudes from the pedal arm to an extent that does not cause an interference with the body of the vehicle when the pedal arm is rotated toward the body of the vehicle, to which the support body is installed.

7. The accelerator apparatus according to claim 1, wherein the protrusion protrudes on an opposite side of the pedal arm, which is opposite from the side where the support body is installed to the body of the vehicle.
